(19) United States
(12) Patent Application Publication
(10) Pub. No.: US 2014/0091067 A1
(43) Pub. Date: Apr. 3, 2014

(54) SOOT PREVENTING DEVICE OF STUD WELDER

(71) Applicants: Sungwoo Hitech Co., Ltd., Busan (KR); Hyundai Motor Company, Seoul (KR)

(72) Inventors: Han Jaehee, Ulsan (KR); Sung Ku Baek, Busan (KR)

(73) Assignees: SUNGWOO HITECH CO., LTD., Busan (KR); HYUNDAI MOTOR COMPANY, Seoul (KR)

(21) Appl. No.: 14/041,232

(22) Filed: Sep. 30, 2013

(30) Foreign Application Priority Data
Sep. 28, 2012 (KR) 10-2012-0109512

(51) Int. Cl. B23K 9/20

(52) U.S. Cl. CPC B23K 9/208; B23K 9/202
USPC 219/98

(57) ABSTRACT

A device that prevents soot in a stud welding machine. In particular, the device includes a cap holder that is fitted on a stud chuck of a stud gun for a stud welding machine and has extenders at the sides thereof. In addition, fixing rods attach the cap holder to the stud gun by connecting the extenders of the cap holder with the sides of the stud gun and a cap that is inserted in the cap holder from below is movably combined with the cap holder by a cap nut, and has an end that comes in contact with an edge of a welding portion of a base material during stud welding. Further, a shock-absorbing member is disposed between the cap and the cap holder, inside the cap holder, and provides an elastic force to the cap.

### CROSS-REFERENCE TO RELATED APPLICATION

This application claims priority to and the benefit of Korean Patent Application No. 10-2012-0109512 filed in the Korean Intellectual Property Office on Sep. 28, 2012, the entire contents of which are incorporated herein by reference.

### BACKGROUND

(a) Field of the Invention

The present invention relates to a device that prevents soot for a stud welding machine. More particularly, the present invention relates to a device that prevents soot for a stud welding machine which improves the quality of coating and external appearance of a base material by preventing soot on the base material.

(b) Description of the Related Art

In general, stud welding, a welding method based on an electronic control technology using the basic principles of arc welding and resistance welding, is a welding method that instantaneously deposits a stud (e.g., a round bar or a bolt) to a base material without boring the base material and is an economical fastening method that satisfies severe conditions for fastening in the industrial field requiring high-strength fastening.

The principle of the stud welding is to weld a metallic stud axially to a base material, that is, to bring a stud supplied on a stud chuck in contact with a base material, to melt the distal end of the stud and the base material by generating an arc between the stud and the base material by instantaneously applying electricity through the stud chuck, and to pressing the stud to the base material such that the molten portion is hardened and deposited onto the base material.

FIG. 1 is an exemplary view showing a stud chuck and related parts of a common stud welding machine. Referring to FIG. 1, in the common stud welding machine, a stud chuck 105 is installed at the end of a stud gun 101 equipped with a pressure cylinder (not shown) therein, via an adapter 103. A stud supply pipe 107 is connected to a side of the stud chuck 105 via a receiver 109. In the stud welding machine, studs S that are supplied through the stud supply pipe 107 are set on the stud chuck 105 via the receiver 109.

In this configuration, the pressure cylinder operates and brings a stud S in contact with a welding portion W on a base material 100 by pushing the stud S and then power is supplied and an arc is generated to melt, press, and deposit the stud S to the base material 100, such that it is possible to perform quick and accurate stud welding on a desired portion of the base material 100. On the other hand, a sustainer 111 is disposed at a side of the stud gun 101 to support the base material 100 during stud welding.

FIG. 2 is an exemplary view illustrating problems occurring at a stud-welded portion in the related art. The stud welding using stud welding machines of the related art has a defect, as shown in FIG. 2, where hydrocarbon particles cause soot 200 around the welding portion W on the base material 100 while being scattered by incomplete combustion in melting foreign substances plated on the surface of the base material 100 and the stud S by using welding heat, such that the external appearance is contaminated and fine spatters are adsorbed on the surface of the base material 100.

As described above, the soot 200 and the fine spatters adsorbed on the surface of the base material 100 reduce the force of coating in a coating process, which causes the quality of coating and external appearance to be deteriorated, such as separation of the coated layer.

The above information disclosed in this section is only for enhancement of understanding of the background of the invention and therefore it may contain information that does not form the prior art that is already known in this country to a person of ordinary skill in the art.

### SUMMARY

The present invention provides a device that prevents soot for a stud welding machine having advantages of improving the quality of coating and external appearance by preventing diffusion and outflow of soot by isolating the area around a welding portion with a cap, and by preventing generation of soot and adsorption of spatters around the welding portion of a base material by guiding fine spatters outward from the welding portion, during stud welding.

An exemplary embodiment of the present invention may provide a device that prevents soot for a stud welding machine, which includes: a cap holder fitted on a stud chuck of a stud gun for a stud welding machine and having extenders at the sides of the cap holder; fixing rods that attach the cap holder to the stud gun by connecting the extenders of the cap holder with the sides of the stud gun; a cap inserted into the cap holder from below, movably combined with the cap holder by a cap nut, and having an end in contact with the edge of a welding portion of a base material during stud welding; and a shock-absorbing member disposed between the cap and the cap holder, inside the cap holder, and providing an elastic force to the cap.

The cap holder may be a hollow part with a cap support step and a spring support step on the inner circumferential surface. The extenders may be formed at both sides of the cap holder. First ends of the fixing rods may be fastened to the extenders, respectively, by assembly bolts and the other ends may be fastened to the sides of the stud gun by fixing brackets. The cap may have a plurality of stud discharge apertures formed through and around the circumferential surface. The spatter discharge apertures may be elliptical -apertures.

The device may further include a pad disposed at the lower end of the cap and in direct contact with the edge of a welding portion of a base material. The pad may be made of a heat resistant material. Specifically, the pad may be made of a silicon nitride or ceramic material. In addition, the pad may be formed in a ring shape, and may be fitted and stopped by the lower end inside the cap and fixed to the cap by a plurality of fixing bolts thread-fastened around the lower end of the cap, and the inner circumferential surface of the pad may be an inclined surface that widens in an upward direction.

The cap nut may be fitted and thread-fastened to the lower end of the cap holder to stop the upper end of the cap to prevent the cap from separating from the cap holder. The shock-absorbing member may be a coil spring with both ends supported by spring support steps formed at the upper end inside the cap holder and the upper end inside the cap and may provide an elastic force downward to the cap against the cap holder.

The device may further include a blower air pipe connected to a side of the cap holder to eject blower air to a welding portion of a base material.

According to an exemplary embodiment of the present invention, it may be possible to prevent spread and outflow of soot by isolating the area around a welding portion of a base material during stud welding, using a cap and a heat resistant ceramic pad and to prevent generation of soot and adsorption of spatters around the welding portion of the base material by guiding fine spatters to the exterior the welding portion, using an inclined surface of the ceramic pad and blower air, to improve the quality of coating and external appearance.

### BRIEF DESCRIPTION OF THE DRAWINGS

FIG. 1 is an exemplary view showing a stud chuck and related parts of a common stud welding machine according to the related art;

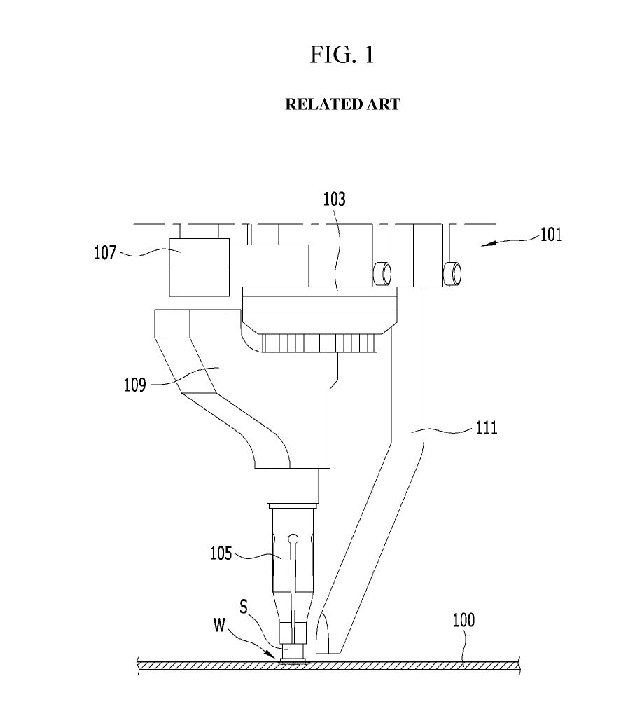

FIG. 2 is an exemplary view illustrating problems occurring at a stud-welded portion according to the related art;

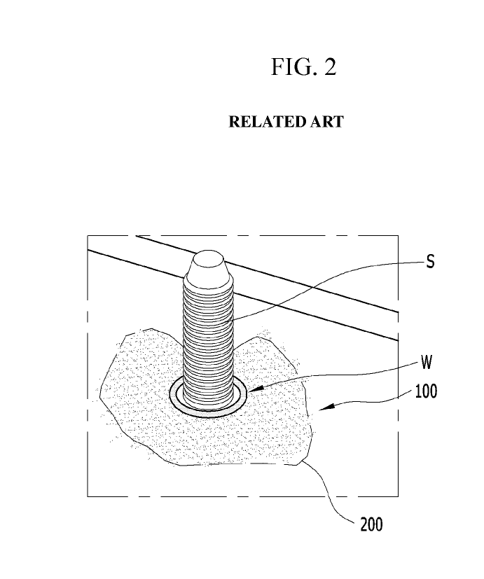

FIG. 3 is an exemplary view showing a stud chuck and related parts of a stud welding machine equipped with a device that prevents soot according to an exemplary embodiment of the present invention;

FIG. 4 is an exemplary detailed view showing a device that prevents soot according to an exemplary embodiment of the present invention;

FIG. 5 is an exemplary detailed view showing the assembled device that prevents soot according to an exemplary embodiment of the present invention;

FIG. 6 is an exemplary cross-sectional view showing the assembled device that prevents soot according to an exemplary embodiment of the present invention;

FIG. 7 is an exemplary view illustrating when the device that prevents soot according to an exemplary embodiment of the present invention is used; and

FIG. 8 is an exemplary view showing a welding portion to show an effect of the device that prevents soot according to an exemplary embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention will be described hereafter in detail with reference to the accompanying drawings. Further, the sizes and thicknesses of the configurations shown in the drawings are provided selectively for the convenience of description, so that unrelated parts in the description are not shown to make the exemplary embodiments of the present invention clear.

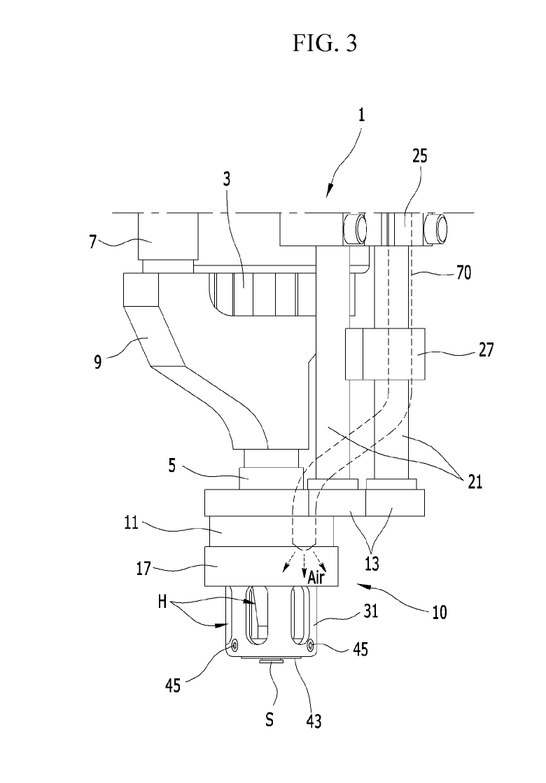

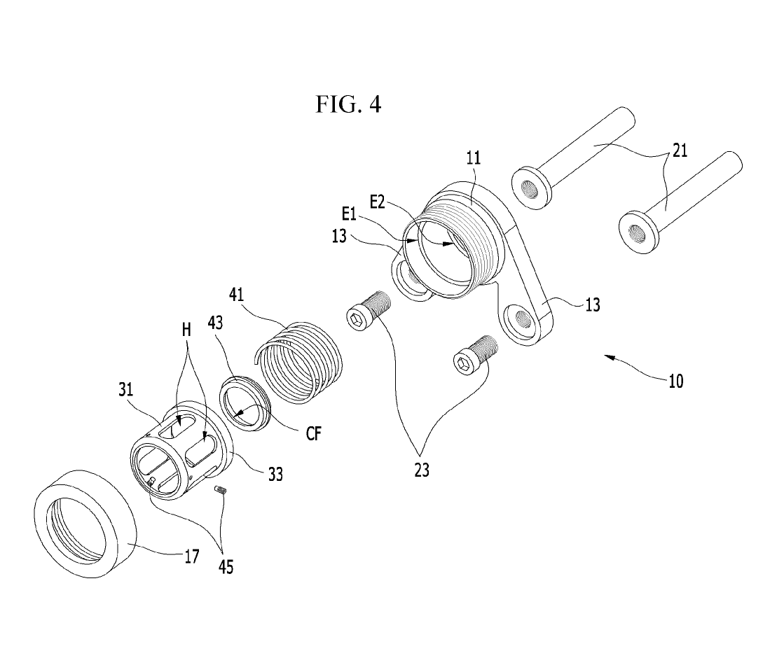

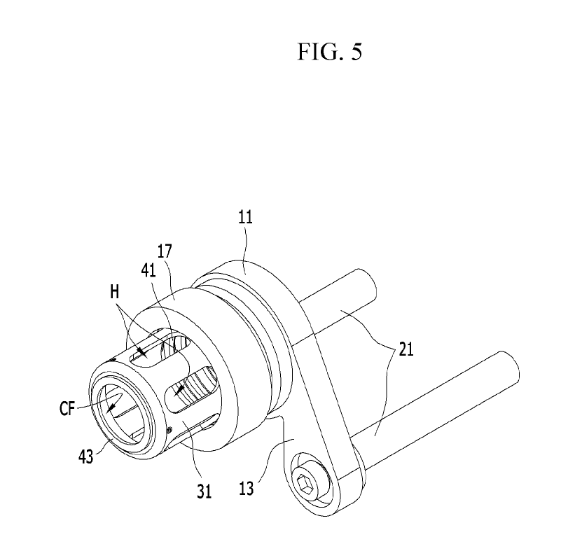

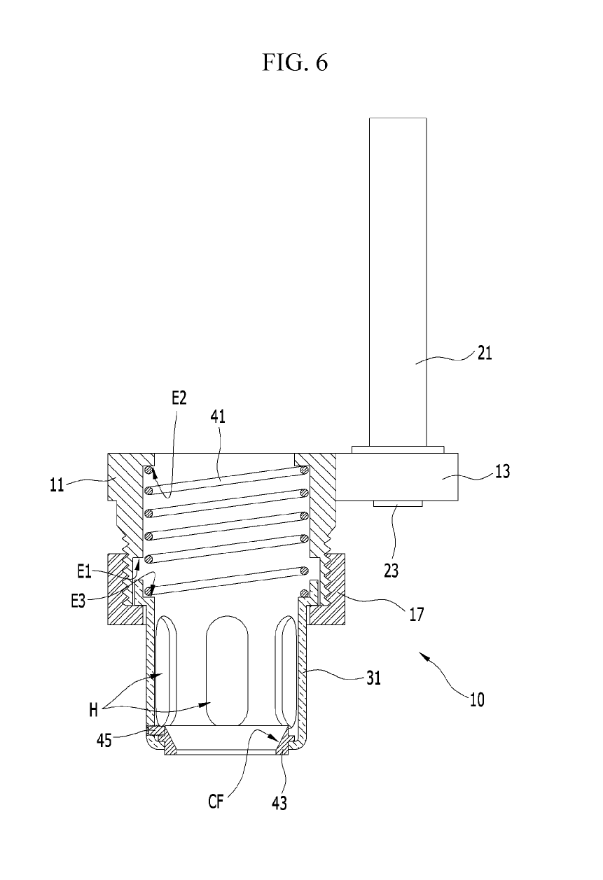

FIG. 3 is an exemplary view showing a stud chuck and related parts of a stud welding machine equipped with a device that prevents soot according to an exemplary embodiment of the present invention, FIG. 4 is an exemplary detailed view showing a device that prevents soot according to an exemplary embodiment of the present invention, FIG. 5 is an detailed exemplary view showing the assembled device that prevents soot according to an exemplary embodiment of the present invention, FIG. 6 is an exemplary cross-sectional view showing the assembled device that prevents soot according to an exemplary embodiment of the present invention.

Referring to FIG. 3, a device 10 that prevents soot may be fitted on a stud chuck 5 of a stud gun 1 for a stud welding machine. The configuration of the stud welding machine is briefly described first. The stud chuck 5 may be installed at the end of the stud gun 1 equipped with a pressure cylinder (not shown) therein via an adapter 3. At a side of the stud gun 1, a stud supply pipe 7 may be connected to a side of the top of the stud chuck 5 via a receiver 9.

Referring to FIGS. 4 and 5, the device 10 that prevents soot, which is fitted on the stud chuck 5 of the stud welding machine having the configuration of FIGS. 4 and 5 may include a cap holder 11, fixing rods 21, a cap 31, and a shock-absorbing member 41.

The cap holder 11 may be fitted on the stud chuck 5 and two extenders 13 may be integrally formed on the sides of the cap holder 11, extending to the sides thereof. The cap holder 11 may be a hollow part with a cap support step E1 and a spring support step E2 on the inner circumferential surface. Two fixing rods 21 having the same shape may be configured to attach the cap holder 11 to the stud gun 1 by connecting the two extenders 13 of the cap holder 11 with both sides of the stud gun 1. In other words, first ends of the fixing rods 21 may be fastened to the extenders 13, respectively, by assembly bolts 23 while second ends may be fastened to the sides of the stud gun 1 by fixing brackets 25.

The two fixing rods 21 may be connected by a connection beam that connects the centers of the fixing rods, to cause the force for fixing to increase. Further, the cap 31 may be inserted into the cap holder 11 from below and movably combined with the cap holder 11 by a cap nut 17. The cap 31 may be sized with tolerances in all directions with respect to the cap holder 11 and the end may be in contact with the edge of a welding portion of a base material during stud welding.

Six spatter discharge apertures H may be formed through and around the circumferential surface of the cap 31, in which the spatter discharge apertures H are elliptical -apertures formed in the longitudinal direction of the cap 31. The cap nut 17 may be fitted and thread-fastened to the lower end of the cap holder 11 to stop the protruding upper end 33 of the cap 31 to prevent the cap 31 from separating from the cap holder 11.

Referring to FIG. 6, the shock-absorbing member 41 may be disposed between the cap 31 and the cap holder 11, inside the cap holder 11, and may provide an elastic force to the cap 31 against the cap holder 11. In other words, the shock-absorbing member 41 may be a coil spring with both ends supported by the spring support step formed at the upper end inside the cap holder 11 and by a spring support step E3 formed at the upper end inside the cap 31, providing an elastic force downward to the cap 31 against the cap holder 11.

A pad 43 in direct contact with the edge of a welding portion of a base member may be disposed at the lower end of the cap 31 and may be made of a heat resistant material. In particular, the pad 43 may be made of a silicon nitride or ceramic material, but it is not limited to that material and any materials that have heat resistance against welding heat, are not bonded or deformed by heat at a welding portion, and have sufficient durability may be used. In other words, the pad 43 may be formed in a ring shape, and may be fitted and stopped by the lower end inside the cap 31 and fixed to the cap 31 by three fixing bolts 45 thread-fastened around the lower end of the cap 31, and the inner circumferential surface of the pad 43 may be an inclined surface CF that widens in an upward direction.

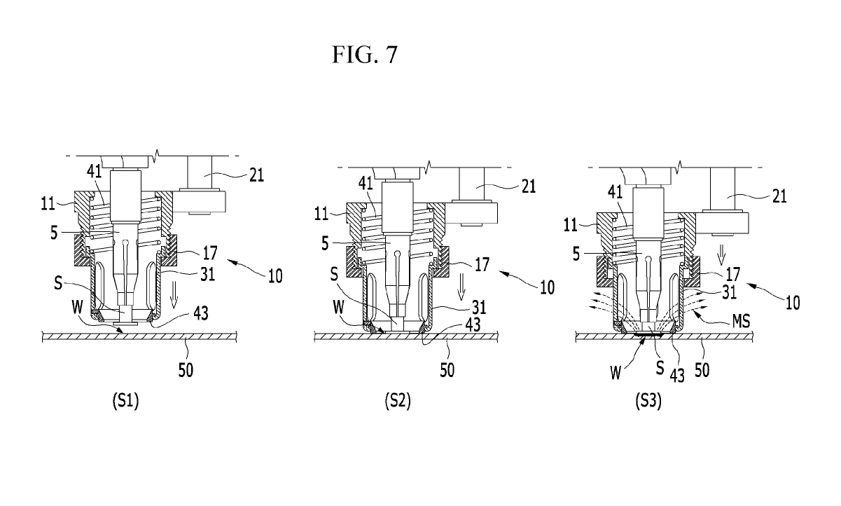

FIG. 7 is an exemplary view illustrating when the device that prevents soot according to an exemplary embodiment of the present invention is used. The device 10 that prevents soot for a stud welding machine, which has the configuration described above, may be fitted on the stud chuck 5 of a stud welding machine and moved to a base material 50 (S1), and then may isolate the area around a welding portion W of the base material in contact with the surface of the welding portion W via the cap 31 right before stud welding (S2). Actually, the pad 43 on the cap 31 may be in contact with the surface of the welding portion W of the base material 50.

Moreover, as the stud welding machine is moved further to the base material 50, the cap 31 is moved inside the cap holder 11 while pressing the shock-absorbing member 41 and the pad 43 stably comes in contact with the surface of the welding portion W of the base material 50 onto which a stud S is welded. In addition, since the cap 31 may move in all directions with respect to the cap holder 11, the pad 43 may be stably brought in contact with the surface of the base material 50.

In this configuration, the stud welding machine pushes the stud S set on the stud chuck 5 by operating the pressure cylinder (not shown) and supplies power while pressing the stud S against the welding portion W on the base material 50 to bond the melting portions of the base material 50 and the stud S by an arc (S3).

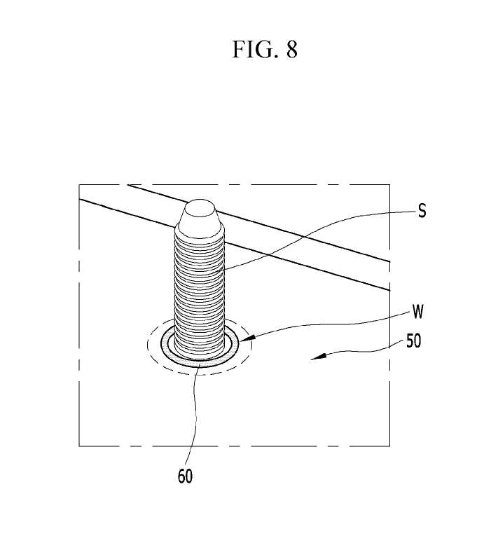

FIG. 8 is an exemplary view showing a welding portion to show an effect of the device that prevents soot according to an exemplary embodiment of the present invention.

As shown in FIG. 8, soot 60 that is generated in the process of melting the surface of the base material 50 and the foreign substance plated on the stud S in the stud welding is generated only inside the welding portion W on the base material 50 which may be isolated by the pad 43 on the cap 31 without spreading.

Referring to “S3” in FIGS. 3 and 7, fine spatters MS generated in the process may be guided along the inclined surface CF of the pad 43 by blower air supplied via a separate blower air pipe 70 to be scattered outside the welding portion W through the spatter discharge apertures H of the cap 31, to prevent the fine spatters MS from being adsorbed to the welding portion W.

As described above, the device 10 that prevents soot according to an exemplary embodiment of the present invention prevents diffusion and outflow of the soot 60 by isolating the area around the welding portion W with the pad 43 on the cap 31 and prevents generation of the soot 60 and adsorption of the fine spatters MS around the welding portion W on the base material by guiding the fine spatters MS outside the welding portion W, thereby improving the quality of coating and external appearance.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

### DESCRIPTION OF SYMBOLS

| | | | |
|---|---|---|---|
| 10: | Device for preventing soot | 1: | Stud gun |
| 3: | Adapter | 5: | Stud chuck |
| 7: | Stud supply pipe | 9: | Receiver |
| 11: | Cap holder | 13: | Extender |
| 17: | Cap nut | 21: | Fixing rod |
| 23: | Assembly bolt | 25: | Fixing bracket |
| 27: | Connection beam | 31: | Cap |
| 41: | Shock-absorbing member | 43: | Pad |
| 45: | Fixing bolt | H: | Spatter discharge hole |
| CF: | Inclined surface | S: | Stud |
| W: | Welding portion | 70: | Blower air pipe |
| 60: | Soot | MS: | Fine spatter |

What is claimed is:

1. A device that prevents soot for stud welding, comprising:
a cap holder fitted on a stud chuck of a stud gun for a stud welding machine and having extenders at the sides thereof;
fixing rods that attach the cap holder to the stud gun by connecting the extenders of the cap holder with the sides of the stud gun;
a cap inserted into the cap holder from below, movably combined with the cap holder by a cap nut, and having one end in contact with an edge of a welding portion of a base material during stud welding; and
a shock-absorbing member disposed between the cap and the cap holder, inside the cap holder, and providing an elastic force to the cap.

2. The device of claim 1, wherein the cap holder is a hollow part with a cap support step and a spring support step on an inner circumferential surface.

3. The device of claim 1, wherein the extenders are formed at both sides of the cap holder.

4. The device of claim 1, wherein first ends of the fixing rods are fastened to the extenders, respectively, by assembly bolts and second ends of the fixing rods are fastened to the sides of the stud gun by fixing brackets.

5. The device of claim 1, wherein the cap has a plurality of stud discharge apertures formed through and around a circumferential surface.

6. The device of claim 5, wherein the spatter discharge apertures are elliptical apertures.

7. The device of claim 1, further comprising:
a pad disposed at a lower end of the cap and in direct contact with the edge of the welding portion of the base material.

8. The device of claim 7, wherein the pad is made of a heat resistant material.

9. The device of claim 7, wherein the pad is formed in a ring shape, and is fitted and stopped by the lower end inside the cap and fixed to the cap by a plurality of fixing bolts thread-fastened around the lower end of the cap, and an inner circumferential surface of the pad is an inclined surface that widens in an upward direction.

10. The device of claim 9, wherein the pad is made of a silicon nitride or ceramic material.

11. The device of claim 1, wherein the cap nut is fitted and thread-fastened to the lower end of the cap holder to stop an upper end of the cap to prevent the cap from separating from the cap holder.

12. The device of claim 1, wherein the shock-absorbing member is a coil spring with both ends supported by spring support steps formed at an upper end inside the cap holder and the upper end inside the cap and provides a downward elastic force to the cap against the cap holder.

13. The device of claim 1, further comprising:
a blower air pipe connected to one side of the cap holder to eject blower air to the welding portion of the base material.

14. A device that prevents soot for stud welding, comprising:
a cap holder fitted on a stud chuck of a stud gun for a stud welding machine and having a plurality of extenders at both sides thereof;
a plurality of fixing rods that attach the cap holder to the stud gun by connecting the plurality of extenders at both sides of the cap holder with the sides of the stud gun;
a cap inserted into the cap holder from below, movably combined with the cap holder by a cap nut, having a plurality of spatter discharge apertures formed through and around a circumferential surface, and having an end that corresponds to an edge of a welding portion of a base material during stud welding;
a shock-absorbing member disposed between the cap and the cap holder, inside the cap holder, and providing an elastic force to the cap;
a pad disposed at a lower end of the cap and in direct contact with the edge of the welding portion of the base material; and
a blower air pipe connected to one side of the cap holder to eject blower air to the welding portion of the base material.

15. The device of claim 14, wherein the cap holder is a hollow part with a cap support step and a spring support step on an inner circumferential surface.

16. The device of claim 14, wherein first ends of the fixing rods are fastened to the plurality of extenders, respectively, by assembly bolts and second ends of the fixing rods are fastened to the sides of the stud gun by fixing brackets.

17. The device of claim 14, wherein the spatter discharge apertures are elliptical apertures.

18. The device of claim 14, wherein the pad is made of a heat resistant material.

19. The device of claim 14, wherein the pad is formed in a ring shape, and is fitted and stopped by the lower end inside the cap and fixed to the cap by a plurality of fixing bolts thread-fastened around the lower end of the cap, and an inner circumferential surface of the pad is an inclined surface that widens in an upward direction.

20. The device of claim 19, wherein the pad is made of a silicon nitride or ceramic material.

21. The device of claim 14, wherein the cap nut is fitted and thread-fastened to the lower end of the cap holder to stop an upper end of the cap to prevent the cap from separating from the cap holder.

22. The device of claim 14, wherein the shock-absorbing member is a coil spring with both ends supported by spring support steps formed at the upper end inside the cap holder and the upper end inside the cap and provides a downward elastic force to the cap against the cap holder.
